(19) United States
(12) Patent Application Publication
(10) Pub. No.: US 2004/0147211 A1
(43) Pub. Date: Jul. 29, 2004

(54) POULTRY DEFEATHERING PROCESS AND APPARATUS

(76) Inventor: Charles R. Mostoller, Langhorne, PA (US)

Correspondence Address: CANTOR COLBURN, LLP, 55 GRIFFIN ROAD SOUTH, BLOOMFIELD, CT, 06002

(21) Appl. No.: 10/248,509

(22) Filed: Jan. 24, 2003

(51) Int. Cl. A22B 5/08; A22C 21/02

(52) U.S. Cl. 452/82

(57) ABSTRACT

A process and apparatus for defeathering a bird comprises simultaneously removing feathers from the bird and spraying an antimicrobial agent containing solution to contact a surface of the bird; and massaging the antimicrobial agent containing solution into hair and feather follicles of the birds.

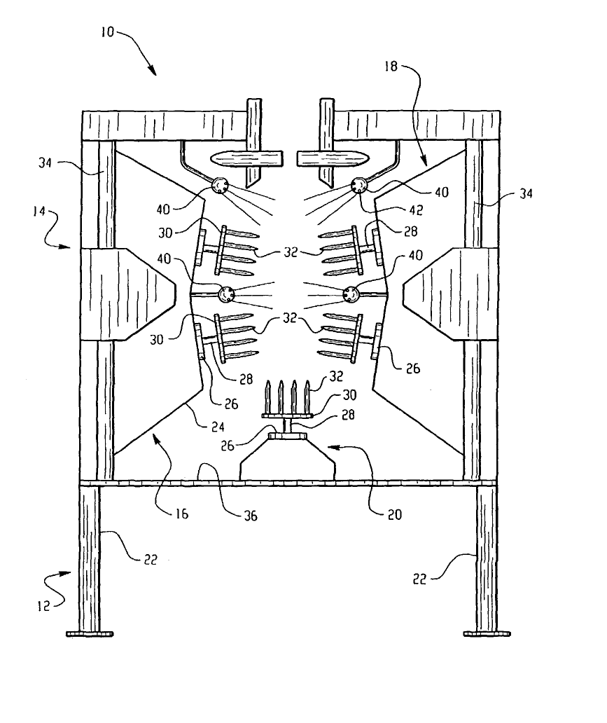

### BACKGROUND OF THE INVENTION

This disclosure generally relates to a process for treating poultry carcasses and more particularly, to a process for treating carcasses with an antimicrobial agent to remove pathogens.

In a typical poultry processing plant, birds are shackled to an overhead conveyor and then, sequentially, pass though various equipment stations that stun, kill, bleed, scald, defeather, eviscerate, and then chill the processed bird for packaging. The defeathering equipment station removes the feathers, typically, with rubber-fingered poultry pickers before the carcasses pass on to the evisceration equipment station for further processing. Prior to entering the defeathering equipment station, the birds are first scalded by immersion in hot water (or exposure to steam) as a means of loosening the feathers. The scalding process can be subject to certain inherent disadvantages. In the first place, the procedure can be unsanitary. The immersion of the birds in a hot water bath can cause the bath to become loaded with microorganisms, fecal matter, and filth of all kinds. This dirty water can then enter into the body cavities through the available openings and thus enter the pulmonary system and the air sac system that extends throughout the body and also in the bones. Moreover, the feathers can become saturated with the dirty water, which can further contaminate the bird. As a result, the processed birds can become contaminated with organisms that can cause spoilage and shorten shelf life.

After scalding, the birds are passed to the defeathering equipment station. Although existing defeathering equipment is typically disinfected at the beginning of the day and feathers may be periodically hosed off, significant cross contamination can occur through the rubbing fingers wiping micro-organisms from bird to bird and from micro-organisms colonized on the fingers being deposited onto the birds. Moreover, it has been found that the rubber-fingered poultry pickers provide a massaging action upon contact with the bird, which can cause microorganism contamination to become deposited within the hair and feather follicles, surface fat, and exposed tissue. Removing, killing, and/or deactivating the microorganism contamination once it has impregnated the hair and feather follicles is not very effective with current defeathering processes and apparatus.

### BRIEF SUMMARY

A process for defeathering a bird comprises simultaneously removing feathers from the bird and spraying an antimicrobial agent containing solution to contact a surface of the bird; and massaging the antimicrobial agent containing solution into hair and feather follicles of the bird.

In another embodiment, a process for defeathering a bird comprises conveying a suspended bird along a predetermined generally horizontal path of travel; applying a series of forces to the bird while suspended to remove the feathers therefrom, the lines of action of the forces being generally parallel to the path of travel of the bird and transverse to a grain of the feathers; and spraying the bird with an antimicrobial agent containing solution while removing the feathers.

A defeathering apparatus comprises a housing; a rotating disc disposed in the housing comprising a plurality of rubber fingers projecting from the disc for contacting the poultry carcass; and a spray manifold mounted in the housing assembly and in fluid communication with a holding tank containing an antimicrobial agent, wherein the spray nozzles are oriented to coat the poultry carcass with the antimicrobial agent.

Those skilled in the art in light of the detailed description and figures will understand further advantages and embodiments of the present disclosure.

### BRIEF DESCRIPTION OF THE DRAWINGS

Referring now to the following Figure, in which a poultry defeathering machine is depicted.

### DETAILED DESCRIPTION

Disclosed herein is a process for treating poultry carcasses with an antimicrobial agent and, more particularly, to a process for treating poultry carcasses with an antimicrobial agent containing solution during a defeathering process. The process is applicable to poultry of all kinds such as, for example, chickens, turkeys, ducks, geese, capons, etc.

Referring now to the Figure, a poultry defeathering machine generally designated is shown. The illustrated poultry defeathering machine 10 is exemplary and is not intended to be limited to any particular defeathering machine. Suitable poultry defeathering machines for practicing the process are also described in U.S. Pat. No. 4,217,678 to Crawford et al., U.S. Pat. No. 3,694,856 to Kaufman et al., U.S. Pat. No. 6,168,510 to Ford, U.S. Pat. No. 5,853,320 to Wathe et al., U.S. Pat. No. 3,596,309 of Vertegaal et al., U.S. Pat. No. 3,747,159 of Harbin et al, U.S. Pat. No. 4,217,678 of Crawford et al., and U.S. Pat. No. 4,514, 879 of Hazenbroek et al., all of which are herein incorporated by reference in their entireties.

Referring now in more detail to the Figure, the poultry defeathering machine 10 generally includes a lower stationary section 12 and an upper section 14 having three picking banks 16, 18, and 20 that straddle a path of travel for poultry suspended from an overhead conveyor line (not shown), e.g. suspended from a shackle. In a preferred embodiment, the orientation of the picking banks is adjustable. The number and arrangement of the picking banks can vary as is known to those skilled in the art. The stationary section 12 includes upright supports 22 at the four corners of the machine 10 and provides a support structure for the upper section 14.

Each one of the picking banks 16, 18 or 20 is seen to comprise a support housing 24 and plate 26 through which a drive shaft 28 is rotatably journaled. A disc 30 is mounted to the end of each shaft 28 while a set of resilient, annularly arranged or arrayed picking fingers 32 is seen to project from the face of each disc 30 and extending away from the support plate 26. A power drive system (not shown) is contained within each support housing 24 for rotatably driving the drive shafts 24 and discs 26. The picking banks 16, 18 are attached to stanchions 34, which extend through collars (not shown) that are secured to the respective housing 16, 18. Picking bank 20 is attached to a bottom floor surface 36 of upper section 14. The picking banks 16, 18, and 20 are preferably adapted to be raised and lowered upon the stanchions 34 or bottom floor surface 36 and may be moved laterally to adjust the gap between confronting picking banks by rotation. In this manner, the defeathering machine can be adapted to process a variety of different sized and types of poultry carcasses. During defeathering, the rubber fingers 32 apply a series of forces to the bird while suspended to remove the feathers therefrom, the lines of action of the forces being generally parallel to the path of travel of the bird and hence transverse to the grain of the feathers thereof.

The defeathering machine 10 further includes one or more spray assemblies for ejecting liquid, fluid, vapor, or other antimicrobial solution to the surrounding boundary environment of the poultry carcass. The spray assembly can comprise one or more tubular members 40 mounted within the upper section 14. The tubular members 40 are preferably horizontally oriented within the upper section 14 relative to the ground and longitudinally oriented relative to the path of travel for the poultry carcass. The tubular members 40 contain a plurality of orifices 42 for spraying the antimicrobial agent solution onto the poultry carcass. The orifices 42 are preferably formed in the tubular member 40 at an angle about perpendicular to the surface of the poultry carcass closest to the tubular member 40. During operation, the spray assembly discharges the antimicrobial agent containing solution at a pressure preferably effective to coat all exterior surfaces the carcass. Preferably, the pressures employed for discharging the antimicrobial agent containing solution through the horizontally oriented tubular members 40 containing the orifices 42 is greater than about 1 pound per square inch (psi), and preferably about 2 to about 50 psi, more preferably about 3 to about 10 and most preferably about 4 to about 7 psi.

Alternatively, the spray assembly may comprise tubular members 40 that contain spray nozzles (not shown), individually or in combination with the orifices 42, to aid in the pressurized disbursement of fluid passing through the system and provide greater control in the direction of the spray. The nozzles are preferably constructed so that they provide the widest cone or flat spray angles and are of a wide bore design. Examples of suitable nozzles include those manufactured by Spray Systems, Inc.

The spray assembly may also include one or more tubular members having a flood or deluge nozzle, individually or in combination with the other types of spray assemblies previously described. The flood or deluge nozzle is preferably a “high volume/low pressure” type nozzle that operates by delivering a high volume of between 0.5 and 1.0 gallon per second of cleaning solution at a pressure of about 5 to about 10 pounds per square inch (psi). The tubular member 40 with the flood nozzle can be horizontally or vertically mounted having its discharge outlet disposed above and directed at the poultry carcass. The discharge outlet is preferably positioned above the carcass to provide a flooding action with the antimicrobial agent containing solution to insure that the surfaces of the poultry carcasses are treated with the antimicrobial agent. The pressures employed for flooding the carcasses with the antimicrobial agent containing solution discharged from vertically oriented tubular members of this type are preferably greater than or equal to about 0.1 psi.

It is noted that commercially available poultry defeathering machines may already contain the necessary plumbing and spray manifolds for rinsing the carcass at various stages of the picking process. As noted in the background, some defeathering processes spray the carcass with water or chlorinated water to increase feather removal effectiveness of the picking banks. In these machines, a diverter valve may be utilized to cause spraying of the antimicrobial agent containing solution during defeathering. In those commercially available defeathering machines that do not include plumbing and spray manifolds, the defeathering machine can be readily modified for coating the surfaces of the poultry carcass with the antimicrobial agent containing solution during the defeathering process in the manner described. It is well within the skill of those in the art to modify, or add the plumbing necessary to delivery the antimicrobial agent containing solution during defeathering.

The antimicrobial solution may be brought in from external sources or may be contained within a pressurized container or tank mounted to the housing structure 12. The size of the tank or container is dependent on the mode of plant operation and can range in size from as little as 50 gallons to as high as 500 gallons. Again, as will be recognized by those in the art, larger sizes may be utilized for larger volumes or sizes of poultry carcasses to be treated. A conduit provides fluid communication between the external source or containers and the tubular members 40 of the spray assemblies. The upper section 14 of the defeathering machine 10 further includes a drain disposed in the upper section bottom surface 36 of the housing structure 12. The antimicrobial agent containing solution collected in the drain is preferably filtered and recirculated back into the container or tank for reuse. Alternatively, the antimicrobial agent containing solution can be used once.

The antimicrobial agent containing solution comprises one or more antimicrobial agents and may contain additional components such as cleaning agents, e.g., a detergent, a brine solution, chlorinated water, or the like. Preferred antimicrobial agents include a trialkali metal phosphate compound of the formula M₃ PO₄. The trialkali phosphate solution can be prepared in accordance with the method set forth in U.S. Pat. No. 5,069,922, which is hereby incorporated by reference in its entirety. Generally, about 4 to about 12 parts of trialkali phosphate are added and mixed in with about 88 to about 96 parts of water to produce a solution that contains between about 4 to about 12% trialkali phosphate by total weight of the solution. In a preferred embodiment, the trialkali metal phosphate is trisodium phosphate. The phosphate solution is effective in removing, reducing, or retarding bacterial contamination.

In accordance with another embodiment, the antimicrobial agent comprises a silicic acid compound. There are no particular restrictions on the silicic acid compound used, as long as this compound is an inorganic silicic acid compound. Usually one or more compounds selected from the group consisting of silicates and silicic acid (and especially silicates) can be used. Examples of silicates that can be used include silicates of alkali metals such as sodium silicate (sodium ortho-silicate, sodium metasilicate and the like), potassium silicate and the like, silicates of alkaline earth metals such as calcium silicate, magnesium silicate and the like, and other silicates such as aluminum silicate and the like. Known compounds or commercially marketed compounds may be used as these silicic acid compounds.

Suitable silicates include alkali metal ortho, meta-, di-, tri-, and tetrasilicates such as sodium orthosilicate, sodium sesquisilicate, sodium sesquisilicate pentahydrate, sodium metasilicate, sodium metasilicate pentahydrate sodium metasilicate hexahydrate, sodium metasilicate octahydrate, sodium metasilicate nanohydrate, sodium disilicate, sodium trisilicate, sodium tetrasilicate, potassium metasilicate, potassium metasilicate hemihydrate, potassium silicate monohydrate, potassium disilicate, potassium disilicate monohydrate, potassium tetrasilicate, potassium tetrasilicate monohydrate, or mixtures thereof. In a preferred embodiment, the silicic acid is a sodium metasilicate.

Generally, when a silicic acid compound is used as the antimcirobial agent, the concentration of the silicic acid compound will range from about 1 wt % to about 10 wt-%, preferably from about 2 wt % to about 8 wt %, and most preferably from about 2 wt % to about 6 wt %.

Alternatively, a combination of the trialkali metal phosphate and the silicic acid compound can be used.

For the purpose of adjusting the pH of the antimicrobial solution, minor amounts of other such agents such as sodium carbonate, sodium and/or potassium hydroxide, alkali metal polyphosphates such as tri polyphosphate or acids such as phosphoric acid may be added. Since hydroxides have an adverse effect on the organoleptic characteristics of the poultry flesh, it is preferred to avoid the use of these basic agents altogether or to use amounts that have no effect on the organoleptic characteristics. The basic agent, if used, is used in an amount insufficient to cause organoleptic deterioration. The term “minor amounts” is meant to be less than about 50% by weight of the combined dry weight of the trialkali metal phosphate and/or silicic acid and the pH-adjusting agent. The temperature of the solution is preferably maintained at between about 70° F. and about 100° F. Higher temperatures are contemplated and may be employed. However, the use of higher temperature will require approval by the United States Department of Agriculture. During spraying, the cleaning solution is preferably at a temperature about 70° F. to about 100° F.

In operation, after hanging live birds on the appropriate shackles, the birds are transported to a stunner station to tranquilize the birds before killing either by hand or by an automatic killer. In the case of hand processing, a stunner may be left out. The poultry carcasses are then bled, which is collected in a bleeding trough. Bleeding time is approx. 2 to 3 minutes. The birds are then immersed in a scalding tank of water (or steam), which features strong agitation pumps to ensure that the birds are always drawn downwards. Depending on whether the final product is fresh or frozen, the birds can be scalded at an elevated temperature, e.g., about 50 to about 60° C. (centigrade) for about 3 to about 4 minutes (for fresh products) or at about 55 to about 65° C. for about 2 to about 2.5 minutes (for frozen products).

After the scalding tank, the bird carcasses pass through the defeathering machine, such as the one described above. The rubber fingers 32 of the picking banks 16, 18, and 20 contact each carcass, which removes the feathers. Simultaneous with the removal of the feathers, the spray assembly sprays the antimicrobial agent containing solution to the surrounding boundary environment of the bird carcass. In this manner, the rubber fingers provide a massaging action (in addition to removing the feathers) and cause the antimicrobial agent to penetrate the hair and feather follicles as well as surface fat areas to kill and/or deactivate any microorganisms present therein.

In a preferred embodiment, the defeathering process comprises more than one stage. In the first stage, defeathering of the bird is preferably performed dry or with a very limited amount of water, antimicrobial agent containing solution, or the like, i.e., enough to dampen the bird carcass. In this manner, no water drainage from these feathers is required, thereby limiting the amount of pollution load of the wastewater or minimizing the amount of antimicrobial agent containing solution used. Preferably, the first stage removes about a majority of the feathers attached to the bird carcass, more preferably, about 70 percent of the feathers are removed, and even more preferably, greater than 90 percent of the feathers are removed. In the subsequent stages, the spray assembly sprays the antimicrobial agent containing solution to the surrounding boundary environment of the bird carcass while the rubber fingers of the picking banks maintain contact with and continue to defeather the bird carcass. In this manner, the amount of antimicrobial agent containing solution applied during defeathering is minimized, thereby providing a cost effective process for reducing overall contamination levels. For example, post evisceration application of an antimicrobial agent containing solution is made much more effective since it is known that current post evisceration processes exhibit poor efficacy when the incoming pathogen levels are relatively high. The pre-evisceration process described herein advantageously lowers the pathogen levels such that the carcasses have relatively light loads of pathogens prior to evisceration.

Advantageously, applying the antimicrobial agent during defeathering and more preferably, after a first stage of the defeathering process is complete, reduces contamination in the poultry carcass. Reducing contamination at an early stage in the poultry processing process, i.e., pre-evisceration, has been found to reduce overall levels of micro-organism contamination after processing is complete. The process prevents colonization of micro-organisms that may be introduced during the scalding process as well as kills or deactivated the micro-organisms present on the surfaces of the bird. Moreover, the massaging action provided by the picking banks for removing the feathers forces the antimicrobial agent into the hair and feather follicles as well as mixes the antimicrobial with surface fat and exposed tissue. The process and apparatus are suitable for use in automated processing systems for preparing poultry.

While the invention has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

1. A process for defeathering a bird, the process comprising:
simultaneously removing feathers from the bird and spraying an antimicrobial agent containing solution to contact a surface of the bird; and
massaging the antimicrobial agent containing solution into hair and feather follicles of the bird.

2. The process according to claim 1, wherein the antimicrobial agent containing solution comprises a trialkali metal phosphate compound of formula M₃ PO₄.

3. The process according to claim 1, wherein the antimicrobial agent containing solution comprises a trialkali metal phosphate compound of formula M₃ PO₄ in an amount of about 4 to about 12 percent by weight based of the soilution.

4. The process according to claim 1, wherein the antimicrobial agent containing solution comprises trisodium phosphate.

5. The process according to claim 1, wherein the antimicrobial agent containing solution comprises a silicic acid.

6. The process according to claim 1, wherein the antimicrobial agent containing solution comprises a silicic acid in an amount of about 1 to about 10 percent by weight of the solution.

7. The process according to claim 1, wherein the bird is selected from the group consisting of a chicken, a capon, a goose, a duck, a turkey, and a pheasant.

8. The process according to claim 1, wherein spraying the antimicrobial agent containing solution to contact a surface of the bird comprises introducing the antimicrobial agent containing solution after a first stage of the defeathering process, wherein the first stage removes a majority of the feathers attached to the bird.

9. The process according to claim 1, wherein spraying the antimicrobial agent containing solution to contact a surface of the bird comprises introducing the antimicrobial agent containing solution after a first stage of the defeathering process, wherein the first stage removes about 70 percent of the feathers attached to the bird.

10. The process according to claim 1, wherein spraying the antimicrobial agent containing solution to contact a surface of the bird comprises introducing the antimicrobial agent containing solution after a first stage of the defeathering process, wherein the first stage removes about 90 percent of the feathers attached to the bird.

11. The process according to claim 1, wherein the antimicrobial agent containing solution further comprises a detergent, brine, chlorinated water, or a combination comprising at least one of the foregoing additives.

12. A process for defeathering a bird, the process comprising:
conveying a suspended bird along a predetermined generally horizontal path of travel; and
applying a series of forces to the bird while suspended to remove the feathers therefrom, the lines of action of the forces being generally parallel to the path of travel of the bird and transverse to a grain of the feathers; and
spraying the bird with an antimicrobial agent containing solution while removing the feathers.

13. The process according to claim 12, wherein applying the series of forces to the bird comprises contacting a surface of the bird with a plurality of rotating rubber fingers extending from a disc or drum.

14. The process according to claim 12, wherein the antimicrobial agent containing solution comprises a trialkali metal phosphate compound of formula M₃ PO₄.

15. The process according to claim 12, wherein the antimicrobial agent containing solution comprises trisodium phosphate.

16. The process according to claim 12, wherein the antimicrobial agent containing solution comprises a silicic acid.

17. The process according to claim 12, wherein the antimicrobial agent containing solution comprises an alkaline metal metasilicate.

18. The process according to claim 12, wherein spraying the bird with the antimicrobial agent containing solution is after about 70 percent of the feathers have been removed.

19. A defeathering apparatus, comprising
a housing;
a rotating disc disposed in the housing comprising a plurality of rubber fingers projecting from the disc for contacting the poultry carcass; and
a spray manifold mounted in the housing assembly and in fluid communication with a holding tank containing an antimicrobial agent, wherein the spray nozzles are oriented to coat the poultry carcass with the antimicrobial agent.
